(19) United States
(12) Patent Application Publication
(10) Pub. No.: US 2018/0279812 A1
(43) Pub. Date: Oct. 4, 2018

(54) MECHANISM FOR KEEPING SHOPPING CARTS WITHIN A STORAGE AREA

(71) Applicant: Walmart Apollo, LLC, Bentonville, AR (US)

(72) Inventors: Ehsan Nazarian, Rogers, AR (US); Behzad Nemati, Springdale, AR (US)

(73) Assignee: Walmart Apollo, LLC, Bentonville, AR (US)

(21) Appl. No.: 15/940,319

(22) Filed: Mar. 29, 2018

Related U.S. Application Data
(60) Provisional application No. 62/479,748, filed on Mar. 31, 2017.

(51) Int. Cl. A47F 10/04; B60T 3/00

(52) U.S. Cl. CPC A47F 10/04; B60T 3/00

(57) ABSTRACT

A mechanism for keeping shopping carts within a storage area and a system for storing shopping carts are described herein. The mechanism includes a mechanical stop disposed at or near the ground at an opening of a storage area that is configured to store a plurality of shopping carts, the mechanical stop being moveable from an upward locked position to a downward unlocked position, the mechanical stop being configured to engage one or more wheels of a shopping cart to keep the shopping cart inside the storage area. The mechanism further includes a release mechanism operatively linked to the mechanical stop, the release mechanism being configured to move the mechanical stop from the upward locked position to the downward unlocked position.

### BACKGROUND

### 1. Technical Field

The present disclosure relates generally to shopping carts and the storage of shopping carts and more specifically to a mechanism for keeping shopping carts within a storage area.

### 2. Introduction

Shopping carts are provided in a retail store and are often located in the vicinity of an entrance of the retail store for easy accessibility by customers. Shopping carts are used by the customers as means to collect shopping items before checkout or purchase at a point of sale in the retail store. Shopping carts are also used by the customers to carry the purchased items from the point of sale in the retail store to a vehicle for unloading the purchased items into the vehicle. After unloading the purchased items, the shopping carts are usually returned to a storage area provided in a parking lot near the retail store. The storage area is used as a collection point for the shopping carts. An employee of the retail store can then bring back the shopping carts inside or near the retail store entrance to be used again by customers. Current configurations of a storage area for shopping carts do not prevent the shopping carts from drifting away from the storage area. As a result, the shopping carts may potentially hit or damage a vehicle in the parking lot. For example, this situation may occur when there is wind that can push a shopping cart away from the storage area.

Therefore, there is a need for a novel system or mechanism for keeping shopping carts within the storage area and preventing the shopping carts from drifting away from the storage area. The system and mechanism disclosed herein cure the above and other problems of existing storage for shopping carts.

### SUMMARY

An aspect of the present disclosure is to provide a mechanism for keeping shopping carts within a storage area. The mechanism includes a mechanical stop disposed at or near the ground at an opening of a storage area that is configured to store a plurality of shopping carts, the mechanical stop being moveable from an upward locked position to a downward unlocked position, the mechanical stop being configured to engage one or more wheels of a shopping cart to keep the shopping cart inside the storage area. The mechanism further includes a release mechanism operatively linked to the mechanical stop, the release mechanism being configured to move the mechanical stop from the upward locked position to the downward unlocked position.

Another aspect of the present disclosure is to provide a storage system for shopping carts. The storage system includes a storage housing having an opening, the storage housing being configured to store a plurality of shopping carts. The storage system further includes a mechanical stop disposed at or near the ground at an opening of the storage housing, the mechanical stop being moveable from an upward locked position to a downward unlocked position, the mechanical stop being configured to engage one or more wheels of a shopping cart to keep the shopping cart inside the storage housing. The storage system also includes a release mechanism operatively linked to the mechanical stop, the release mechanism being configured to move the mechanical stop from the upward locked position to the downward unlocked position.

Additional features and benefits of the disclosure will be set forth in the description which follows, and in part will be obvious from the description, or can be learned by practice of the herein disclosed principles. The features and benefits of the disclosure can be realized and obtained by means of the instruments and combinations particularly pointed out in the appended claims. These and other features of the disclosure will become more fully apparent from the following description and appended claims, or can be learned by the practice of the principles set forth herein. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

FIGS. 1a and 1b show a mechanism for keeping shopping carts within a storage area, according to an embodiment of the present disclosure;

FIGS. 2a and 2b show positions of the mechanism for keeping shopping carts within the storage area when actuated, according to an embodiment of the present disclosure; and

FIGS. 3a and 3b depict schematically the mechanism for keeping shopping carts within a storage area, according to an embodiment of the present disclosure.

### DETAILED DESCRIPTION

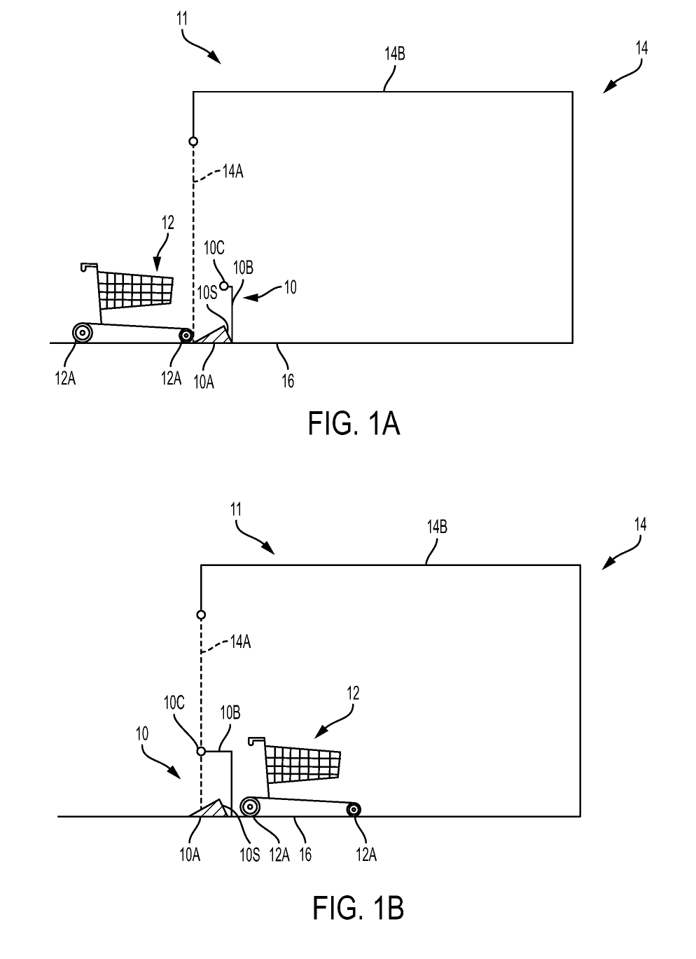

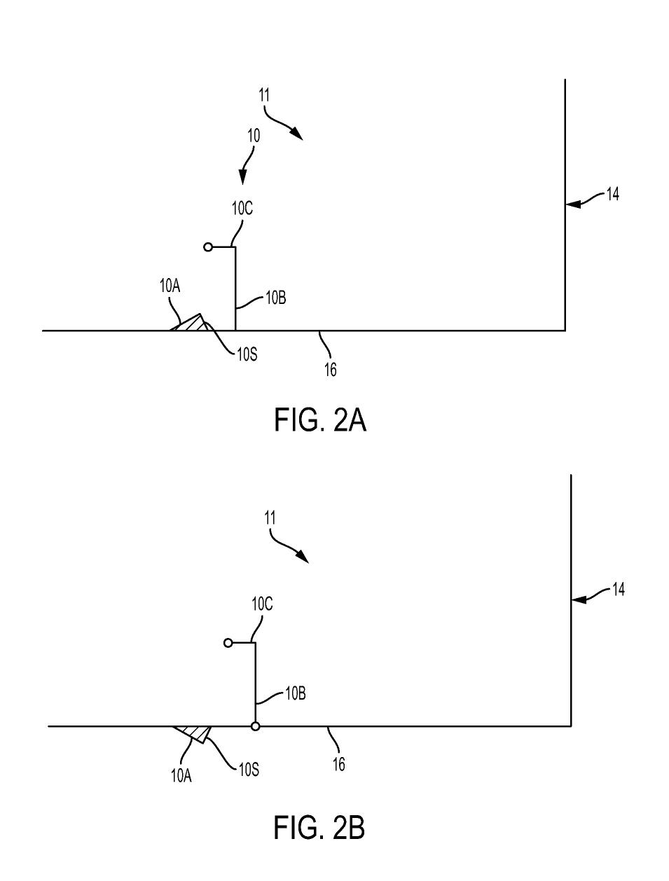

FIGS. 1a and 1b show a mechanism 10 for keeping shopping carts 12 within a storage area 14, according to an embodiment of the present disclosure. The mechanism 10 includes a mechanical stop 10A disposed at or near the ground 16 at an opening 14A of the storage area 14. The storage area 14 is configured to store a plurality of shopping carts 12. In an embodiment, the storage area 14 is a rectangular or square shaped area enclosed on three sides and a fourth side having the opening 14A to allow ingress and egress of a shopping cart 12 into and from the storage area 14. Of course, other shapes and sizes of the storage area 14 are also contemplated by the disclosure. In an embodiment, the opening 14A has a dimension to allow more than one shopping cart 12 to be inserted into the storage area 14 at once. In an embodiment, the storage area 14 has a rooftop 14B to cover or provide shade to the shopping carts stored in the storage area 14. In another embodiment the storage area 14 does not have a rooftop, as shown in FIGS. 2a and 2b. The storage area 14 can be made from any suitable material including, but not limited to, metal, wood or plastic, or any combination of two or more of these materials.

FIGS. 2a and 2b show positions of the mechanism 10 when actuated, according to an embodiment of the present disclosure. The mechanical stop 10A is moveable from an upward locked position, as shown in FIG. 2a, to a downward unlocked position, as shown in FIG. 2b. In an embodiment, when in the upward locked position as shown in FIGS. 1a, 1b and 2a, the mechanical stop 10A is configured to engage one or more wheels 12A of the shopping cart 12 when a user pushes the shopping cart towards the entrance 14A to store the shopping cart within the storage area 14. When in the upward locked position, as shown in FIGS. 1a, 1b and 2a, the mechanical stop 10A is also configured to engage part of the shopping cart 12, such as one or more wheels 12A of the shopping cart 12 to keep the shopping cart 12 inside the storage area 14, as shown in FIG. 1b.

In an embodiment, the mechanical stop 10A has a shape adapted to allow the shopping cart 12 to enter the storage area 14 and prevent backward movement of the shopping cart 12 out of the storage area 14. In an embodiment, the mechanical stop 10A has a wedge-like profile in a form of a ramp, as depicted in FIGS. 1a-2b, to facilitate insertion of the shopping cart 12, in a forward movement of the shopping cart 12 into the storage area 14 and prevent the shopping cart 12 to move backward out of the storage area 14, while the mechanical stop 10A is in the upward locked position, as shown in FIGS. 1a, 1b and 2a. For example, the mechanical stop 10A can be a bump that protrudes from the ground 16 or from near the ground 16 when in the locked upward position as shown in FIG. 2a, and is recessed in the ground or near the ground 16 or flush with the ground 16, when in the unlocked downward position as shown in FIG. 2b. The mechanical stop (e.g., bump or protrusion) 10A has a surface 10S that engages mechanically part of the shopping cart 12, such as one or more wheels 12A of the shopping cart 12 to prevent the shopping cart 12 from moving out of the storage area when the bump 10A is in the upward locked position, as shown in FIG. 2a. For example, as depicted in FIG. 1b, the mechanical stop 10A engages the wheels 12A at the back of the shopping cart 12 thus preventing the shopping cart 12 from moving out of the storage area 14.

The mechanical stop 10A may be incorporated into storage area 14. For example, a cross piece may be provided along the ground, across opening 14A. The mechanical stop 10A may be disposed in the cross piece such that the stop 10A protrudes from and is recessed into the cross piece. The cross piece may have a profile that accommodates the stop 10A and allows the shopping carts to move into and out of the storage area. In another example, the mechanical stop may be provided in the ground or in a recess in the ground.

Although the mechanical stop 10A is shown in the FIGS. 1a, 1b, 2a and 2b, as having a triangular or wedge profile shape, as it can be appreciated, the mechanical stop 10A can have other shapes such as a curved shape or trapezoid shape. The main feature of the mechanical stop 10A is to engage part of the shopping cart 12, such as one or more wheels 12A of the shopping cart 12 to prevent the shopping cart 12 from leaving the storage area 14 once the shopping cart 12 is pushed into the storage area 14, when the mechanical stop 10A is in the upward locked position. This feature can be accomplished by providing a steep or abrupt surface 10S of the mechanical stop 10A or by providing a protrusion (e.g., a bump) in the mechanical stop 10A with a sufficient height such that the one or more wheels 12A of the shopping cart 12 cannot overcome the height of the protrusion without lifting the shopping cart 12. The steep surface 10S can be dimensioned such that it engages one or more wheels 12A of the shopping cart 12 to prevent the shopping cart 12 from moving out of the storage area 14.

The mechanism 10 also includes a release mechanism 10B operatively linked to the mechanical stop 10A. The release mechanism 10B is configured to move the mechanical stop 10A from the upward locked position, as shown in FIG. 2a, to the downward unlocked position, as shown in FIG. 2b. In an embodiment, the release mechanism 10B comprises a handle 10C located in or near the storage area 14 near the opening 14A. In an embodiment, the release mechanism 10B is configured to be activated manually to move the mechanical stop 10A from the locked upward position, as shown in FIG. 2a, to the unlocked downward position, as shown in FIG. 2b. The handle 10C may be provided at about waist level or may be operated via a foot pedal.

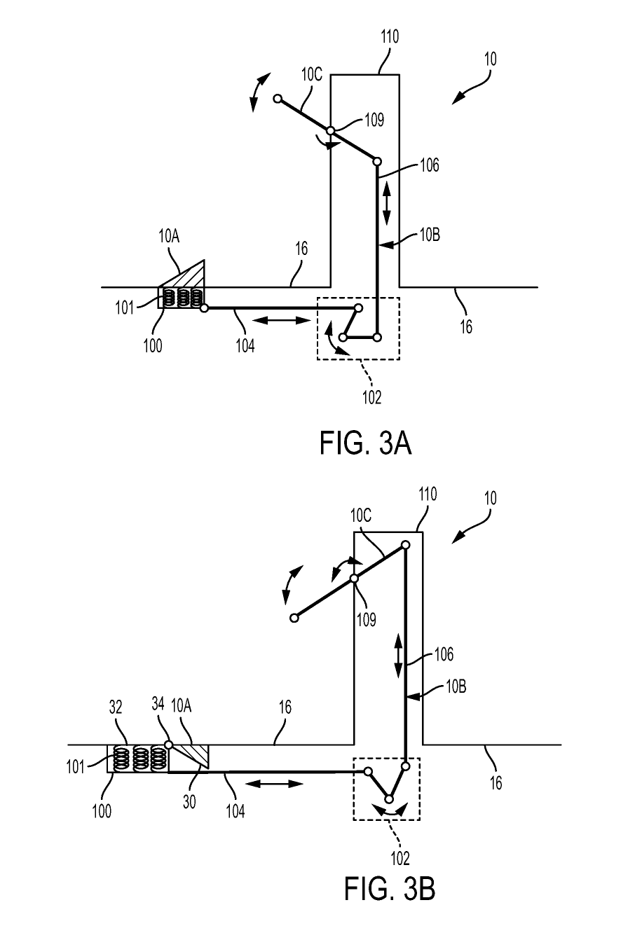

FIGS. 3a and 3b depict schematically the mechanism 10 for keeping shopping carts 12 within a storage area 14, according to an embodiment of the present disclosure. As shown in FIGS. 3a and 3b, the mechanism 10 includes the release mechanism 10B that is operatively linked to the mechanical stop 10A (e.g., a wedge-like stop). The release mechanism 10B comprises the handle 10C. The release mechanism 10B also comprises a spring board 100 that is moveable to contact the mechanical stop 10A. The spring board 100 includes one or more resilient members 101 (e.g., springs). The spring board 100 is configured to bias the mechanical stop 10A to the upward position when brought in contact with the mechanical stop 10A. The resilient members 101 may be compressed or flex when a shopping cart 12 is pushed into the storage area 14. Thus, the spring board 100 and mechanical stop 10A may move at least partially downward to facilitate to movement of the shopping cart 12 into the storage area 14. The resilient members 101 may be selected to have a resiliency that gives way under the force applied to the shopping cart moving into the storage area 134.

The release mechanism 10B also includes a pivot joint 102 and a first linkage arm 104 that links the pivot joint 102 to the spring board 100. The release mechanism 10B also includes a second linkage arm 106 that links the pivot joint 102 to the handle 10C. In an embodiment, the handle 10C is pivotally connected to a support structure 110 via pivot point 109.

In an embodiment, the mechanical stop 10A is configured to move from the downward unlocked position as shown in FIG. 2b to the locked upward position as shown in FIG. 2a automatically once the shopping cart 12 is removed from the storage area. For example, the mechanical stop 10A can be spring loaded by the spring board 100 including the one or more resilient members 101. The spring board 100 can be arranged to automatically move the mechanical stop 10A from the unlocked downward position to the locked upward position once the shopping cart 12 is removed from the storage area 14. The handle or lever 10C of the release mechanism 10B is linked to the mechanical stop 10A via the second linkage arm 106, pivot joint 102 and the first linkage arm 104. Therefore, actuation of the lever or handle 10C can move the mechanical stop 10A between the upward locked position and the downward unlocked position.

In operation, initially the spring board 100 is in contact with the mechanical stop 10A. Therefore, the mechanical stop 10A is biased to the upper locked position, as shown in FIG. 3a. In this configuration, the handle or lever 10C is in the upper position (activated position). When the handle or lever 10C is in the upper position, as shown in FIG. 3a, the second linkage arm 106 moves downwardly to actuate the pivot joint 102. This movement of the second linkage arm 106 along with the actuation of the pivot joint 102 in turn moves the first linkage arm 104 to pull the spring board 100 towards the mechanical stop 10A. In some embodiments, the spring board includes a top surface 32 that engages with a bottom surface 30 of the mechanical stop 10A. Movement of the top surface 32 along the bottom surface 30 causes the mechanical stop to pivot upward about pivot 34. In other cases, the mechanical stop 10A is simply moved upwards. As a result, the mechanical stop 10A is brought to the upper locked position by the biasing force of the spring board 100. In this position, the mechanical stop 10A engages one or more wheels 12A of the shopping cart 12 to prevent the shopping cart 12 from leaving the storage area 14 once the shopping cart 12 is pushed into the storage area 14, as illustrated in FIG. 1b.

When a user actuates the handle or lever 10C, for example by pulling down the handle or arm 10C, as shown in FIG. 3b, the arm or handle 10C pivots around pivot point 109 and the second linkage arm 106 is moved upwardly to actuate the pivot joint 102. This movement of the second linkage arm 106 along with the actuation of the pivot joint 102 in turn moves the first linkage arm 104 to push the spring board 100 away from the mechanical stop 10A. As a result, the biasing force of the spring board 100 is removed and the mechanical stop 10A is brought to the lower unlocked position. The converse of the above movements of the mechanical stop 10A may occur to lower the mechanical stop 10A. When the mechanical stop 10A is in the downward unlocked position, as shown in FIG. 2b and FIG. 3b, the shopping cart 12 can be pulled out from the storage area 14 without the one or more wheels 12A of the shopping cart being hindered by the mechanical stop 10A. This facilitates pulling out the shopping cart 12 from the storage area 14. For example, this can be performed by an employee of the retail store when retrieving the one or more shopping carts 12 from the storage area 14 to take them back to the retail store to be used again by customers of the retail store.

Although the release mechanism 10B is described in the above paragraphs as having first and second linkage arms 104 and 106 and a pivot joint 102, as it can be appreciated other types of release mechanisms can also be used to control a movement of the mechanical stop 10A. For example, instead or in addition to the linkage-type mechanism depicted in FIGS. 3a and 3b, a gear-type mechanism can also be used. In addition, although the release mechanism 10B is described above as being manually actuated, the release mechanism 10B can also be actuated using a motor.

The term “locked upward position” is used herein to indicate that the mechanical stop 10A when in the upward position is locked in the sense that the one or more wheels 12A when engaging the mechanical stop 10A, the mechanical stop 10A does not move into the downward position as shown in FIG. 2b. The mechanical stop 10A does not move to the downward position shown in FIG. 2b unless the release mechanism 10B is actuated. The term “unlocked downward position” is used herein to indicate that the mechanical stop 10A is unlocked using the release mechanism 10B to put the mechanical stop 10A in the downward position, as shown in FIG. 2b. In an embodiment, as the mechanical stop 10A is unlocked in the downward position, the mechanical stop 10A can also be configured to automatically return to the upward position, for example by using a spring loading device (not shown), or by re-actuating the release mechanism 10B to enable the mechanical stop 10A to return to the upward locked position.

As it must be appreciated from the above paragraphs, there is also provided a storage system 11 for shopping carts 12. The shopping carts storage system 11 includes the storage housing 14 having the opening 14A. The storage housing 14 is configured to store a plurality of shopping carts 12. The storage housing 14 is described in detail in the above paragraphs. The storage system 11 also includes the mechanical stop 10A described in detail in the above paragraphs. The storage system 11 further includes the release mechanism 10B that is operatively linked to the mechanical stop 10A. The release mechanism 10B is configured to move the mechanical stop 10A from the locked upward position as shown in FIG. 2a to the unlocked downward position as shown in FIG. 2b.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A mechanism for keeping shopping carts within a storage area, the mechanism comprising:
a mechanical stop disposed at or near the ground at an opening of a storage area that is configured to store a plurality of shopping carts, the mechanical stop being moveable from an upward locked position to a downward unlocked position, the mechanical stop being configured to engage one or more wheels of a shopping cart to keep the shopping cart inside the storage area;
a resilient member configured to be moveable from a first position, upwardly biasing the mechanical stop in the upward locked position, to a second position, moving the mechanical stop to the downward unlocked position; and
a release mechanism operatively linked to the resilient member, the release mechanism being configured to move the resilient member between the first position and the second position, whereby the mechanical stop is moved between the upward locked position and the downward unlocked position.

2. The mechanism according to claim 1, wherein the mechanical stop is configured to keep the shopping cart within the storage area and prevent the shopping cart from drifting away from the storage area.

3. The mechanism according to claim 1, wherein the storage area is a rectangular or square shaped area enclosed on three sides and a fourth side having the opening to allow ingress and egress of the shopping cart into and from the storage area.

4. The mechanism according to claim 3, wherein the opening has a dimension to allow more than one shopping cart to be inserted into the storage area at once.

5. The mechanism according to claim 1, wherein the release mechanism comprises a handle located in or near the storage area near the opening.

6. The mechanism according to claim 1, wherein the release mechanism is configured to be activated manually to move the mechanical stop from the locked upward position to the unlocked downward position.

7. The mechanism according to claim 6, wherein the mechanical stop is configured to move from the downward unlocked position to the locked upward position automatically once the shopping cart is removed from the storage area.

8. The mechanism according to claim 7, wherein the mechanical stop is spring loaded by a resilient member, the mechanical stop having a bottom surface and being arranged to pivot about a pivot point to move the mechanical stop from the unlocked downward position to the locked upward position as the resilient member slides along the bottom surface of the mechanical stop.

9. The mechanism according to claim 1, wherein the mechanical stop is a bump that protrudes from the ground or from near the ground when in the locked upward position and is recessed in the ground or near the ground when in the unlock downward position.

10. The mechanism according to claim 9, wherein the bump has a surface that engages mechanically the one or more wheels of the shopping cart to prevent the shopping cart from moving out of the storage area.

11. The mechanism according to claim 1, wherein the mechanical stop has a shape adapted to allow the shopping cart to enter the storage area and prevent backward movement of the shopping cart out of the storage area.

12. The mechanism according to claim 1, wherein the mechanical stop has a wedge-like profile in a form of a ramp to facilitate insertion of the shopping cart, in a forward movement of the shopping cart, into the storage area and prevent the shopping cart to move backwards out of the storage area.

13. The mechanism according to claim 1, wherein the release mechanism includes:
a handle coupled to the storage area;
a first linkage arm coupled to the resilient member via a pivot joint;
a second linkage arm coupled to the pivot joint and to the handle, the second linkage arm configured to move vertically upon actuation of the handle, thereby the first linkage arm horizontally about the pivot joint.

14. A storage system for shopping carts comprising:
a storage housing having an opening, the storage housing being configured to store a plurality of shopping carts;
a mechanical stop disposed at or near the ground at an opening of the storage housing, the mechanical stop being moveable from an upward locked position to a downward unlocked position, the mechanical stop being configured to engage one or more wheels of a shopping cart to keep the shopping cart inside the storage housing; and
a release mechanism operatively linked to the mechanical stop, the release mechanism being configured to move the mechanical stop from the upward locked position to the downward unlocked position.

15. The storage system according to claim 14, wherein the storage housing has a rooftop.

16. The storage system according to claim 14, wherein the mechanical stop is configured to keep the shopping cart within the storage housing and prevent the shopping cart from drifting away from the storage housing.

17. The storage system according to claim 14, wherein the storage housing is a rectangular or square shaped housing enclosed on three sides and a fourth side having the opening to allow ingress and egress of shopping cart into and from the storage housing.

18. The storage system according to claim 17, wherein the opening has a dimension to allow more than one shopping cart to be inserted into the storage housing at once.

19. The storage system according to claim 14, wherein the release mechanism comprises a handle located in or near the storage housing near the opening.

20. The storage system according to claim 14, wherein the release mechanism is configured to be activated manually to move the mechanical stop from the locked upward position to the unlocked downward position.

21. The storage system according to claim 20, wherein the mechanical stop is configured to move from the downward unlocked position to the locked upward position automatically once the shopping cart is removed from the storage housing.

22. The storage system according to claim 21, wherein the mechanical stop is spring loaded with a resilient member, the resilient member being arranged to automatically move the mechanical stop from the unlocked downward position to the locked upward position once the shopping cart is removed from the storage housing.

23. The storage system according to claim 14, wherein the mechanical stop is a bump that protrudes from the ground or from near the ground when in the locked upward position and is recessed in the ground or near the ground when in the unlock downward position.

24. The storage system according to claim 23, wherein the bump has a surface that engages mechanically the one or more wheels of the shopping cart to prevent the shopping cart from moving out of the storage housing.

25. The storage system according to claim 14, wherein the mechanical stop has a shape adapted to allow the shopping cart to enter the storage housing and prevent backward movement of the shopping cart out of the storage housing.

26. The storage system according to claim 14, wherein the mechanical stop has a wedge-like profile in a form of a ramp to facilitate insertion of the shopping cart, in a forward movement of the shopping cart, into the storage housing and prevent the shopping cart to move backwards out of the storage housing.
